(19) United States
(12) Patent Application Publication
(10) Pub. No.: US 2011/0264555 A1
(43) Pub. Date: Oct. 27, 2011

(54) METHOD AND SYSTEM FOR PROVIDING FEATURE TO TEMPORARILY HOLD ONE-OF-A-KIND MERCHANDISE IN AN ONLINE SHOPPING CART

(75) Inventor: Suzanne M. Turner-Rielle, Midland, MI (US)

(73) Assignee: RIELLE LIFE LLC, Midland, MI (US)

(21) Appl. No.: 13/093,092

(22) Filed: Apr. 25, 2011

Related U.S. Application Data
(60) Provisional application No. 61/328,269, filed on Apr. 27, 2010.

(51) Int. Cl. G06Q 30/00

(52) U.S. Cl. 705/26.8

(57) ABSTRACT

The present invention is a method and system for conducting electronic commerce which allows a customer to place an item on hold online, in the customer's shopping cart, and changing the status of the item to temporarily unavailable, so that users other than the customer may view the item, but may not purchase the item unless it is made available again, either at the end of a defined time period or because the customer decides to take the item out of their shopping cart. This is a desirable feature for items that are unique, one-of-a-kind, or of limited availability.

### BACKGROUND OF THE INVENTION

1. Field of the Invention

This invention pertains in general to electronic commerce and in particular to a method and system for providing a temporary “hold” in an online shopping cart for items that are one-of-a-kind.

2. Description of the Related Art

Most consumers are familiar with shopping at a physical retail store and the concept of placing an item on hold. For example, if a consumer sees an item they are interested in purchasing but would like to wait until making a final purchase, the retail merchant will set the physical item aside for a period of time. During that period of time, other customers are not able to purchase the item. If the consumer for whom the item has been set aside does not return to purchase the item before the time period expires, then the item is placed back on the retail shop floor and other customers may then purchase that item.

Today, consumers do not only shop at physical retail stores, but electronic commerce on the internet has also become commonplace. There are many merchants offering goods and services on web sites on the internet, and there are an even greater number of customers who purchase the goods and services. In many cases, the electronic commerce transaction involves physical goods.

In some cases a shopping cart is used to make an electronic purchase. For example, U.S. Pat. No. 7,640,193 describes a centralized version of a shopping cart. Typically, a shopping cart is used to set aside an item and allow a consumer to decide whether or not to purchase the item while it is in their shopping cart. However, the status of the item in the shopping cart does not change while it is in the shopping cart. The item in these situations is just one of many items that are available from an inventory of numerous like items. In fact, U.S. Pat. No. 6,990,488 describes a model for use in tracking the physical inventory that is sold via electronic commerce methods.

Some electronic commerce systems even allow a consumer to monitor status of items. For example, U.S. Pat. No. 7,483,846 describes a service for notifying users when an out-of-stock item from an electronic catalog becomes available, and U.S. Pat. No. 6,047,264 describes a method for automatically notifying a customer of the status of an electronic commerce transaction that has already been completed.

None of the above described approaches permit a consumer to place an item on hold, similar to the on-hold procedure in a physical retail store, which would set the item aside for that particular consumer and would prevent other consumers from purchasing the item for a period of time. This on-hold feature is particularly important for items that are unique, one-of-a-kind, or of limited availability.

### SUMMARY OF THE INVENTION

In one aspect, the present invention is a method of conducting electronic commerce comprising:
using a computer to perform steps comprising storing a virtual shopping cart linked to a customer, receiving from the customer linked to the shopping cart instructions to place a unique item in the shopping cart, and changing the status of the item in the shopping cart to temporarily unavailable such that users other than the customer may view the item but may not purchase the item.

In another aspect, the present invention is an electronic commerce system having a computer-readable storage medium having computer-executable code, the computer-executable code comprising a unique item having a status identifier; a shopping cart module for temporary storage of one or more unique item identifiers for potential purchase by a customer; a time period control module associated with the shopping cart module for triggering the shopping cart to empty once a time period has expired; and an item state control module for changing the unique item status identifier when it is placed into the shopping cart module and thereafter when the time period has expired.

The present invention allows a customer to place an item on hold online, also referred to herein as temporarily unavailable, in the customer's shopping cart, so that users other than the customer may view the item, but may not purchase the item unless it is made available again, either at the end of the time period or because the customer decides to take the item out of their shopping cart. This is a desirable feature for items that are unique, one-of-a-kind, or of limited availability.

### BRIEF DESCRIPTION OF THE DRAWINGS

FIG. 1 illustrates the components of an electronic commerce system that implements a cart hold service according to one embodiment of the invention.

FIG. 2 illustrates one example of the use of a cart hold service of the embodiment of FIG. 1.

FIG. 3 illustrates another example of the use of a cart hold service of the embodiment of FIG. 1.

FIG. 4 illustrates another example of the use of a cart hold service of the embodiment of FIG. 1.

### DETAILED DESCRIPTION OF SPECIFIC EMBODIMENTS

One specific embodiment of the invention, referred to interchangeably herein as an “Online Hold service” or a “Cart Hold service”, will now be described with reference to the drawings. This embodiment is intended to illustrate, and not limit, the present invention. The scope of the invention is defined by the claims.

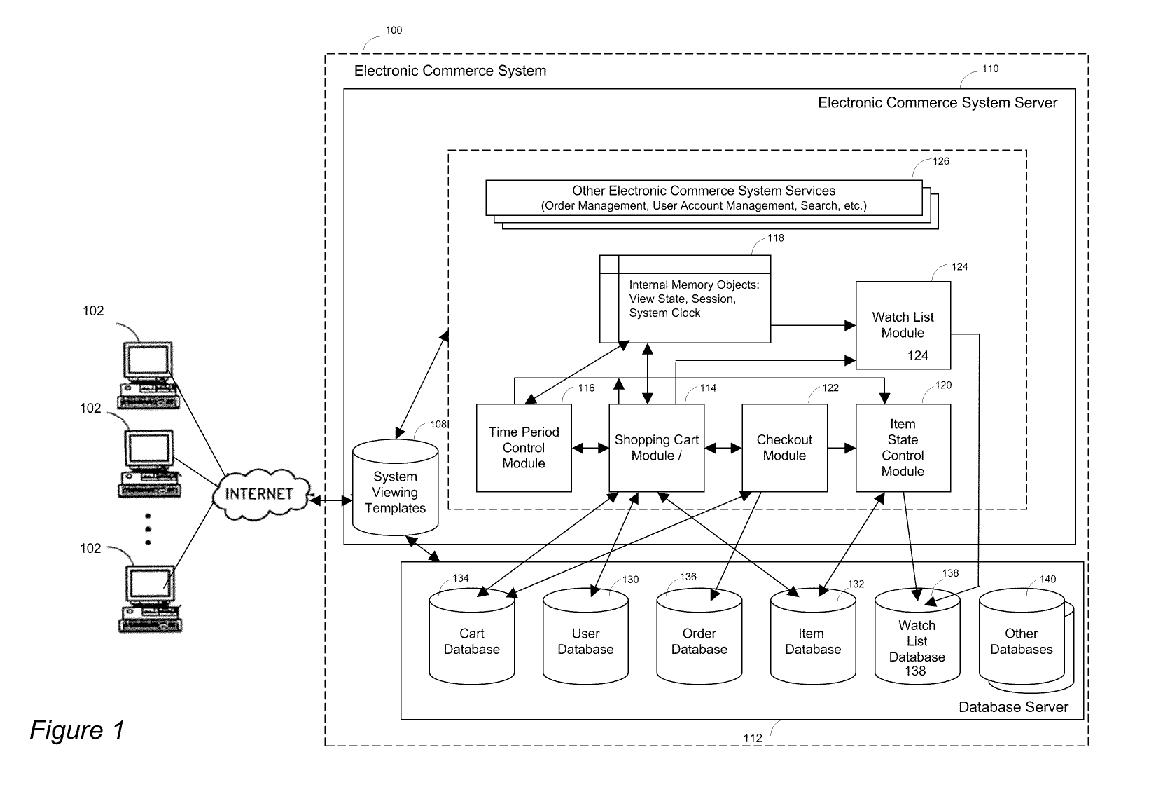

FIG. 1 illustrates the components of an electronic commerce system 100 that implements a Cart Hold service according to one embodiment of the invention. The system 100 includes a electronic commerce server 110, which is represented as a single electronic commerce server but may be distributed electronic commerce servers located in the same or different locations, that services requests from user computerized devices 102 (PC's, PDA's, web-enabled phones, web-enabled electronic reading devices and tablets, other mobile devices, etc.) over the internet.

The term “customer” as used herein means the consumer involved in the specific transaction being described. The term “user” as used herein means consumers other than the customer. Customers and users may be classified as a “visitor” or as a “registered member”. A “visitor” is defined as being a guest or someone who does not register with the website. Visitors can shop without registering. A “registered member” means the customer provides requested personal information and receives a user name and password to log in to the site, has an account and may be able to track purchases and other historical information. The term “registered member” is not intended to be limiting, and terms such as “registered user” or “frequent user” or other similar term may be used to describe this type of user, so long as the term represents a user that receives a login name and password to the website.

Referring again to FIG. 1, the Database Server 112, represented herein as a single server but may be multiple distributed servers in the same or different locations, contains an Item Database 132 of information about unique items that are available for purchase. The term “item”, also referred to herein as “unique item” means a unique, one-of-a-kind piece of merchandise, which can be one individual article or which may be a grouping of more than one article. It has specific characteristics and identifier associated with it, and there is or may be only one available. The items represented within the Item Database 132 may include physical products and combinations thereof, such as apparel, books, DVD's, and other consumer products, and/or may include downloadable items and combinations thereof such as software products, music files, and video files. Although depicted as a single Item Database 132 for purposes of illustration, the item information may be distributed across multiple-distinct databases. The system 100 may support business-to-consumer sales of items, wherein a business includes for-profit and not-for-profit organizations, consumer-to-consumer sales of items, business-to-business sales of items, or any combination of all of these types of sales. The term “sale” is defined herein to mean an exchange of goods for some form of consideration having approximately equal value, including sale for any amount of cash (including zero), swapping, trading, exchanging goods for credit, and other similar transactions. Various types of attribute data may be stored in the Item Database 132 for each item, such as, for example, the item's price and availability, images of the item, item traits, detailed description of the item, editorial reviews of the item, user and customer reviews of the item, user and customer questions and seller answers to questions, etc. The change in the attribute associated with the item's availability, is referred to generally as a change in the item's status.

An item's status in the Item Dababase 132 is controlled, monitored, and updated by an Item State Control Module 120. The Item State Control Module 120 interfaces with the Shopping Cart Module 114 and the Checkout Module 122 and updates an item's status on a real time basis as transactions occur.

The term “shopping cart” as used herein is not critical and is not intended to be limiting, referring to an area that is used for reserving items for a particular user. Terms such as “shopping bag”, “cart”, “my selections”, “my choices”, “reserved” and other similar terms may also be used.

Item availability may be represented as available for purchase or unavailable. Available items are presented to the user when the Item Database 132 is searched via system viewing Templates 108 that are on the system 100. If an item in the database is unavailable, it may be temporarily unavailable in accordance with the present invention, or it may be permanently unavailable.

The term “temporary” as used herein means that there is a specific time period in which the item is kept in the shopping cart. An item's status is updated to temporarily unavailable when added to the Shopping Cart Module 114, described in more detail below, in which case the Item State Control Module 120 will update the item's status to unavailable. The item status may be represented to users as “unavailable”, “on hold”, or any other term that indicates the item is temporarily unavailable, even though other users may still view the item. Alternatively, the item itself may be unviewable by other users.

An item's status is updated to permanently unavailable if it is purchased through the Checkout Module 122, in which case the Item State Control Module 120 will update the Item's status to unavailable, and may optionally be represented to users as being “sold”. The term “purchase” as used herein is defined to mean an acquisition of goods for some form of consideration having approximately equal value, including cash (including zero), swapping, trading, exchanging goods for credit, and other similar transactions. The term “sold” as used herein is intended to mean that a sale (as defined hereinabove) has been completed. An item's status is also updated to permanently unavailable if the item's marketplace listing has expired as determined by Item Database 132 settings, the date the item was added to the database, and the system date/time clock, in which ase the item may optionally be represented to users as being “expired” or any other similar term. An item's status is also updated to permanently unavailable if the item is deleted by the seller and physically removed from the database by another automated service module 126.

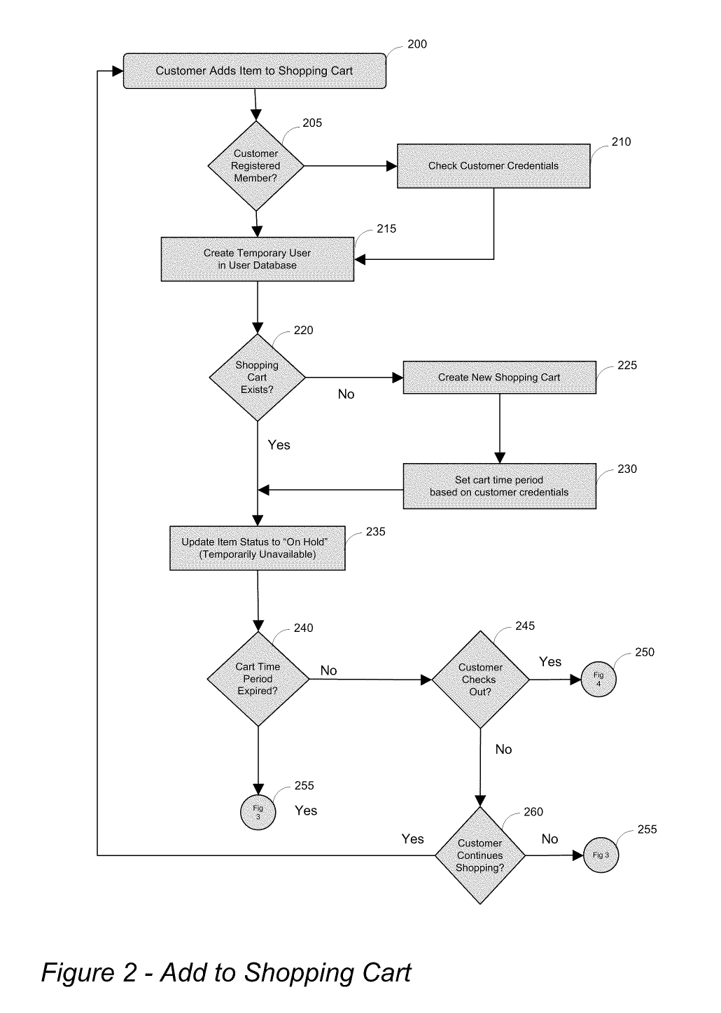

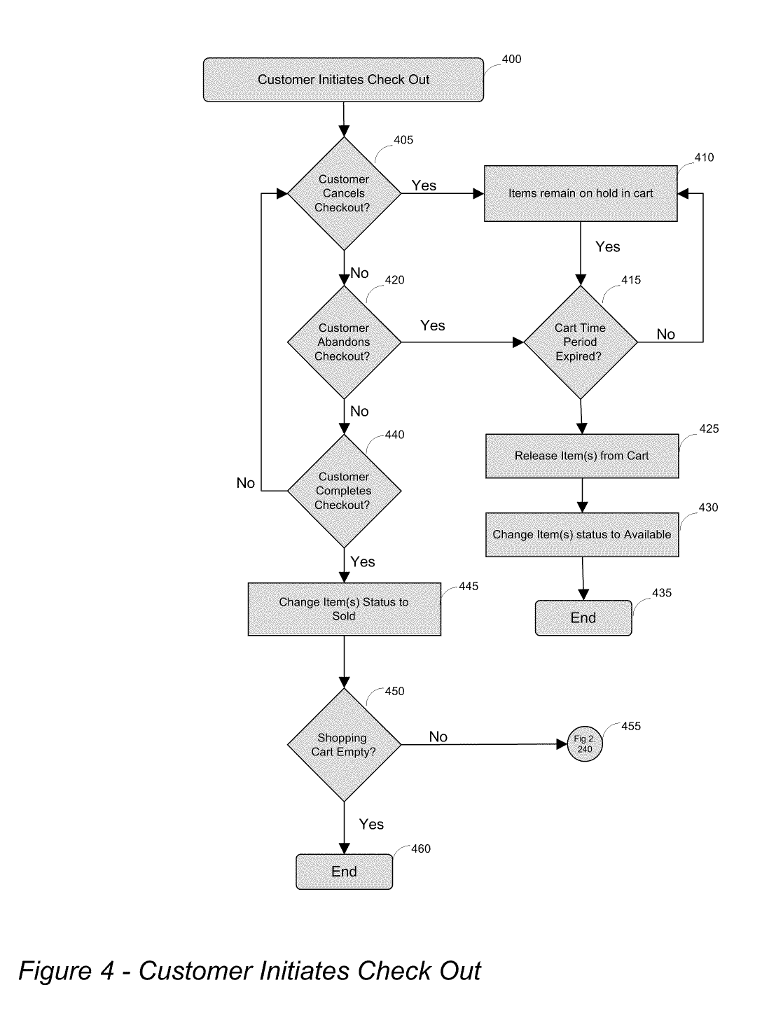

When a customer elects to add an item to their shopping cart (as shown in FIG. 2) or begins the checkout process (as shown in FIG. 4) for an item, the Time Period Control Module 116, described in more detail below, works together with the Shopping Cart Module 114 and Internal Memory/System Clock/Session State 118 to establish and save the time the customer performed the action. Furthermore, the Shopping Cart Module 114 communicates with the Item State Control Module 120 to trigger an update to the Item's status to temporarily unavailable (or “on hold”, as described above). In this temporarily unavailable state, an Item may still be viewable by another user who is browsing the Item Database 132 via the System Viewing Templates 108, but the action of adding the item to their shopping cart is not available. In this case, the user has an option to add it to a Watch List Database 138, further described below, and optionally be notified by a system alert, such as by way of an email message, text message, mobile alert or other type of automated alert, when the item's status changes back to “Available” or permanently unavailable (including “Sold”, “expired”, “completed”, “ended”, or the like).

If the customer elects to complete the purchase of an item, Checkout Module 122 will communicate with the Shopping Cart Module 114 to remove the item from their shopping cart, and will communicate with the Item State Control Module 120, which will change the status of the item from temporarily unavailable, i.e. “on hold’, to permanently unavailable, which may be represented as a “sold” status. Sold items are then only viewable by the customer who purchases the item via the System Viewing 108 via the Order Database 136 and Item Database 132. The Order Database 136 retains the identity of the purchaser, seller, item details, and additional information about each order. If a customer abandons their transaction during the Checkout process (as shown in FIG. 4) or never completes their transaction, such that an Order in the Order Database 136 is created, parameters for the Shopping Cart Module 114 and the Time Period Control Module 116 may be set to retain their active shopping cart and hold selected items in their shopping cart until the original time periods for the shopping cart or Items are reached.

The Web Site System 100 also comprises a Time Period Control Module 116. At least one Time Period Control Module 116 is associated with the Shopping Cart Module 114 such that the time period for which the shopping cart is active, and/or the time period in which items are in the shopping cart can be monitored. The Time Period Control Module 116 monitors one or more time periods associated with a shopping cart and/or an item(s), and counts the amount of time that an item has been kept within a shopping cart based on a System Clock 118. The time period may start as soon as the first item is placed in the shopping cart and the Time Period Control Module 116 can control the time that the shopping cart is active. The term “active” as used herein with regard to the shopping cart means that an item has been placed into the shopping cart by a user. Alternatively, there may be a separate time period associated with each item, such that there will be multiple time periods associated with a shopping cart and can control the length of time an item is held in the shopping cart. In this case, a customer having placed multiple items in their shopping cart will see items disappear from their shopping cart as the time periods for each item expire (unless they have otherwise purchased an item or decided to take an item out of the shopping cart.) The Time Period Control Module 116 may be a separate module from the the Shopping Cart Module 114, as shown in FIG. 1, or it may itself be within the Shopping Cart Module 114, which is shown as a single module for the purposes of illustration or may be comprised of multiple modules. The time remaining in a time period, or the time having elapsed, may be visible to the customer, or it may be invisible. If visible, the time period may be represented to the customer and optionally to other users in various forms, such as a “cart timer”, “countdown clock”, “on hold time” or other similar representation. If the time period is invisible to the customer, then the customer can be notified when the time period has expired or is close to expiring by email (or any other integrated messaging system) notification, system alert, or by simply checking the shopping cart to see whether the item is still in the cart or not.

If the customer adds an item to their shopping cart (as shown in FIG. 2), the Shopping Cart Module 114 creates a shopping cart in a Cart Database 134, which is represented as a single database for purposes of illustration or may be comprised of multiple databases within or outside the Electronic Commerce System 100. Additionally, Internal Memory 118 and a customer's View State 118 of the cart is established. The Time Period Control Module 116 monitors the customer's shopping cart and session with the System Clock 118. This Time Period Control Module 116 can monitor can establish when a customer's shopping cart was created and/or when an item is added to the customer's shopping cart. Parameters in the Time Period Control Module 116 can be set differently for different types of customers based on their membership credentials in the User Database 130. When a shopping cart is created the Shopping Cart Module 114 checks the User Database 130 to determine if the customer is registered member on the system or a guest (also referred to as a “visitor”), and verifies their member details. The Time Period Control Module 116 can monitor different time periods, which may vary based on the type of customer. For example, a registered member may be permitted to keep an item in its shopping cart for a longer time period than a customer having only visitor status. To further exemplify this concept, the time period for a registered member can vary anywhere from 1 minute, or 5 minutes, or even 15 or 30 minutes, to 1 day, 7 days, 15 days, 30 days, or even longer; whereas for a visitor, the time period might vary from 1 minute, 5 minutes or even 15 or 30 minutes, to just 1, 2, 5 or 7 days. The time period can also vary depending on the item. For example, a more valuable item might have a shorter time period associated with it than a less valuable item.

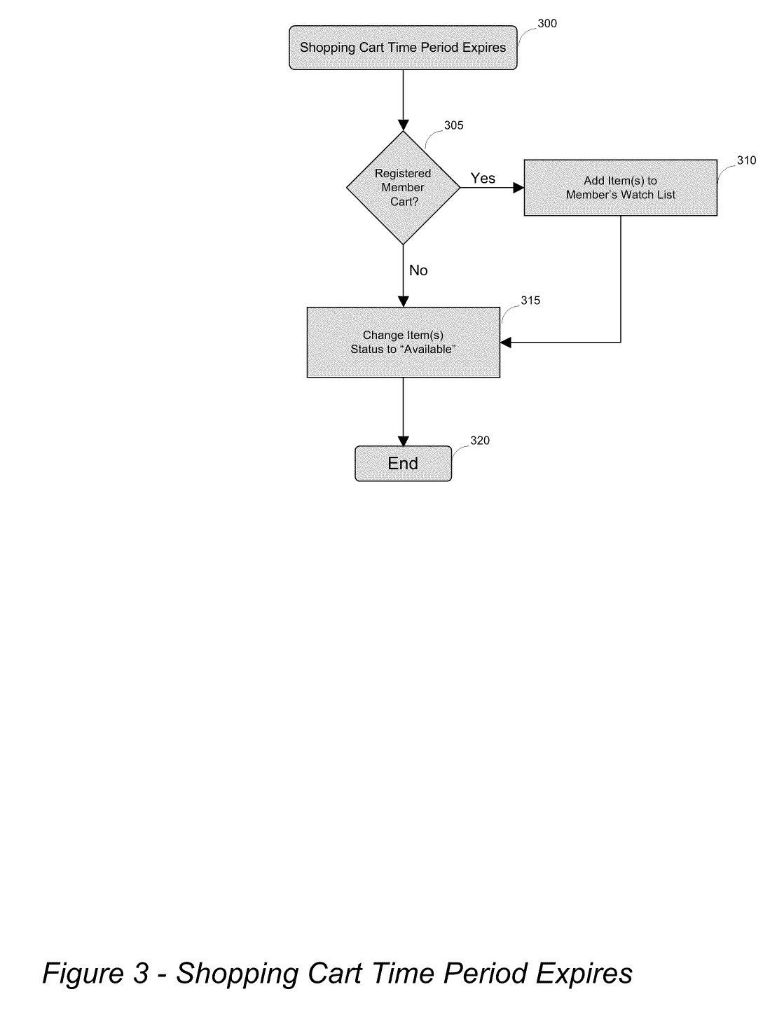

Based on the parameters set, the Timer Period Control Module 116 works with the System Clock 118 to monitor the cart and items in the cart. When the time period for a cart or an item is reached, the Time Period Control Module 116 triggers the Shopping Cart Module 114 to release the items from their temporarily unavailable status and remove them from the customer's shopping cart (as shown in FIG. 3). If all items are removed from the customer's shopping cart, it will appear to the customer as empty or expired, or it may completely disapper from their view.

When an item or cart's time period has expired, the item may optionally be added to a Watch List Database 138 (as shown in FIG. 3) The concept of a “watch list” is sometime represented as a “wish list” or other similar representation. The item may be added to the Watch List Database 138 automatically, or elected optionally by the customer. In this manner, the shopping cart can communicate with a Watch List Module 134 that controls these options and can automatically update the Watch List Database 138. Items in the Watch List Database 138 are viewable by a customer based on their membership credentials in the User Database 130 and via the System Viewing Templates 108. When a customer or other registered user views their Watch List, the Watch List database displays the item's Available, On Hold, or Unavailable status based on the current status of the item in the Item Database 132.

A customer may decide to remove an item from their shopping cart before the time period associated with their cart or an item is set to expire. In this case the Shopping Cart Module 114 communicates with the Item State Control Module 120, which changes the item's status back to “available” in the Item Database 138. Optionally in this case, a customer may elect to add the item to their Watch list, as described above.

The Electronic Commerce System 100 optionally also includes various other services, such as a catalog service, a search service, a customer reviews service, an item management service, and an order management service. Each service may, for example, be implemented as a web service that may be accessed by other services of the Electronic Commerce System 100.

Referring now to FIG. 2, once a user decides to place an item on hold they become a customer. FIG. 2 describes one embodiment of the steps a customer would follow using a computer when placing an item on hold. FIG. 3 then describes an embodiment of what would happen if the time period expires when an item is in the customer's cart. FIG. 4 then describes an embodiment of what would happen if the customer initiates checkout but then abandons or cancels the checkout process. As used herein, the terms “checkout” and “checkout process” (used interchangeably) mean completing a transaction after a customer has decided that they want an item, wherein the customer takes final steps to complete the purchase of the item, including confirmation of the purchase, providing shipping information, and providing payment information (as applicable).

While the foregoing description makes reference to preferred embodiments, the scope of the invention is defined solely by the claims that follow and the elements recited therein.

What is claimed is:

1. A method of conducting electronic commerce comprising:
using a computer to perform steps comprising:
storing a virtual shopping cart linked to a customer;
receiving from the customer linked to the shopping cart instructions to place a unique item in the shopping cart; and
changing the status of the item in the shopping cart to temporarily unavailable such that users other than the customer may view the item but may not purchase the item.

2. The method of claim 1 further comprising: deleting the item from the shopping cart after the expiration of a time period.

3. The method of claim 2 wherein the time period varies based on classification of the customer.

4. The method of claim 3 wherein the time period for a customer having a visitor classification is from 1 minute to 7 days.

5. The method of claim 3 wherein the time period for a customer having a registered member classification is from 1 minute to 30 days.

6. The method of claim 2 further comprising changing the status of the item to“available”.

7. The method of claim 1 further comprising deleting the item from the shopping cart when the customer purchases the item and thereafter changing the status of the item to “sold”.

8. The method of claim 1 further comprising deleting the item from the shopping cart when the customer sends an instruction to remove the item from the shopping cart and thereafter changing the status of the item to “available”.

9. An electronic commerce system having a computer-readable storage medium having computer-executable code, the computer-executable code comprising:
a unique item having a status identifier;
a shopping cart module for temporary storage of one or more unique item identifiers for potential purchase by a customer;
a time period control module associated with the shopping cart module for triggering the shopping cart to empty once a time period has expired; and
an item state control module for changing the unique item status identifier when it is placed into the shopping cart module and thereafter when the time period has expired.

10. The system of claim 9, wherein the time period control module is within the shopping cart module.

11. The system of claim 9, wherein the time period control module is a separate module from the shopping cart module.

12. The system of claim 9, wherein the time period control module counts the time period for which the shopping cart module has been activated.

13. The system of claim 9 wherein the time period control module counts the time period for which an item has been placed in the shopping cart.

14. The system of claim 9, further comprising:
a checkout module for completing a purchase of the unique item upon instructions from the customer, wherein the checkout module is linked to the item state control module to signal a change to the unique item status identifier when a purchase is completed.

15. The system of claim 9, further comprising:
a watch list module that permits users other than the customer to monitor the change of the status identifier for the unique item, wherein the watch list module is linked to the item state control module in order to reflect changes in the unique status identifier.

16. The system of claim 15, wherein the watch list module is automatically triggered when the time period associated with the shopping cart module expires.
